(19) United States
(12) Patent Application Publication
(10) Pub. No.: US 2023/0415543 A1
(43) Pub. Date: Dec. 28, 2023

(54) THERMAL SENSATION ESTIMATION DEVICE, AIR CONDITIONING DEVICE, CHILD SAFETY SEAT, THERMAL SENSATION ESTIMATION METHOD, AND PROGRAM

(71) Applicant: Panasonic Intellectual Property Management Co., Ltd., Osaka (JP)

(72) Inventors: Aki YONEDA, Hyogo (JP); Mototaka YOSHIOKA, Osaka (JP); Shinichi SHIKII, Nara (JP); Rina AKAHO, Osaka (JP)

(73) Assignee: Panasonic Intellectual Property Management Co., Ltd., Osaka (JP)

(21) Appl. No.: 18/244,111

(22) Filed: Sep. 8, 2023

Related U.S. Application Data
(63) Continuation of application No. PCT/JP2021/048944, filed on Dec. 28, 2021.

(30) Foreign Application Priority Data
Mar. 11, 2021 (JP) 2021-039710

(51) Int. Cl. B60H 1/00

(52) U.S. Cl. CPC B60H 1/00742

(57) ABSTRACT

A thermal sensation estimation device includes a metabolic amount estimator, a released heat flux estimator, and a thermal sensation estimator. The metabolic amount estimator is configured to estimate a metabolic amount of a user. The released heat flux estimator is configured to estimate a released heat flux as a heat flux released outside from the user. The thermal sensation estimator is configured to estimate thermal sensation of the user based on the metabolic amount and the released heat flux. The metabolic amount estimator is configured to measure a height of the user to estimate the metabolic amount based on the height measured.

### CROSS-REFERENCE TO RELATED APPLICATIONS

The present application is a Bypass Continuation of International Application No. PCT/JP2021/048944 filed on Dec. 28, 2021, which is based upon and claims the benefit of priority to Japanese Patent Application No. 2021-039710, filed on Mar. 11, 2021, the entire contents of both applications are incorporated herein by reference.

### TECHNICAL FIELD

The present disclosure generally relates to thermal sensation estimation devices, air conditioning devices, child safety seats, thermal sensation estimation methods, and programs. More particularly, the present disclosure relates to a thermal sensation estimation device configured to estimate thermal sensation of a user, an air conditioning device, a child safety seat, a thermal sensation estimation method, and a program.

### BACKGROUND ART

JP 2016-169942 A (hereinafter referred to as “Patent Literature 1”) discloses an air conditioner configured to obtain a body temperature of a person and an ambient temperature from a thermal image, calculate a different value between the body temperature and the ambient temperature obtained, and estimate thermal sensation of the person based on a difference between the different value calculated and a threshold. The air conditioner stores therein thresholds for individuals. The air conditioner obtains a height of the person from the thermal image, and specifies an individual based on a difference of the height obtained. The air conditioner deals with an individual difference in the thermal sensation by using a threshold corresponding to the individual specified, of the thresholds.

The air conditioner disclosed in Patent Literature 1 is needed to previously store therein the thresholds for the individuals. For that reason, if the thresholds previously stored include no threshold corresponding to a certain person, the air conditioner may not estimate the thermal sensation of the certain person with high accuracy. In particular, when the certain person is an infant, who cannot express one's thermal sensation (such as hot or cold) accurately, setting a threshold corresponding to the infant is not easy. Therefore, the room for improving accuracy of estimating the thermal sensation is large.

### SUMMARY

It is therefore an object of the present disclosure to provide a thermal sensation estimation device, an air conditioning device, a child safety seat, a thermal sensation estimation method, and a program, all of which contribute to improving accuracy of estimating thermal sensation of a user.

A thermal sensation estimation device according to an aspect of the present disclosure includes a metabolic amount estimator, a released heat flux estimator, and a thermal sensation estimator. The metabolic amount estimator is configured to estimate a metabolic amount of a user. The released heat flux estimator is configured to estimate a released heat flux as a heat flux released outside from the user. The thermal sensation estimator is configured to estimate thermal sensation of the user based on the metabolic amount and the released heat flux. The metabolic amount estimator is configured to measure a height of the user to estimate the metabolic amount based on the height measured.

An air conditioning device according to an aspect of the present disclosure includes the thermal sensation estimation device, an air conditioning unit and a controller. The air conditioning unit is configured to perform air conditioning. The controller is configured to control the air conditioning unit based on the thermal sensation of the user, estimated by the thermal sensation estimation device.

A child safety seat according to an aspect of the present disclosure is installed to a rear seat in a car to hold an infant. The child safety seat includes the thermal sensation estimation device and a controller. The controller is configured to control an air conditioning device based on the thermal sensation of the infant, estimated by the thermal sensation estimation device.

A thermal sensation estimation method according to an aspect of the present disclosure is performed by a thermal sensation estimation device. The thermal sensation estimation method includes estimating a metabolic amount of a user, estimating a released heat flux as a heat flux released outside from the user, and estimating thermal sensation of the user based on the metabolic amount and the released heat flux. The thermal sensation estimation method includes, during the estimating of the metabolic amount, measuring a height of the user to estimate the metabolic amount based on the height measured.

A program according to an aspect of the present disclosure is designed to cause one or more processors to perform the thermal sensation estimation method.

### BRIEF DESCRIPTION OF THE DRAWINGS

The figures depict one or more implementation in accordance with the present teaching, by way of example only, not by way of limitations. In the figures, like reference numerals refer to the same or similar elements.

FIG. 1 is a block diagram of a thermal sensation estimation device according to a first embodiment of the present disclosure;

FIG. 2 is a flowchart for explaining about how the thermal sensation estimation device operates;

FIG. 3 is a flowchart for explaining a metabolic amount estimation processing in operation of the thermal sensation estimation device;

FIG. 4 is a flowchart for explaining a processing of displaying thermal sensation information in operation of the thermal sensation estimation device;

FIG. 5 is a schematic diagram of a car using an air conditioning system including the thermal sensation estimation device;

FIG. 6A is a diagram showing a display example (green coloring and a high level of transmittance) of the thermal sensation information, provided by the thermal sensation estimation device;

FIG. 6B is a diagram showing another display example (green coloring and an intermediate level of transmittance) of the thermal sensation information, provided by the thermal sensation estimation device;

FIG. 6C is a diagram showing yet another display example (green coloring and “0” of transmittance) of the thermal sensation information, provided by the thermal sensation estimation device;

FIG. 7 is a diagram showing a display example of height and age information, provided by the thermal sensation estimation device;

FIG. 8 is a block diagram of an air conditioning device according to a second embodiment of the present disclosure; and

FIG. 9 is a block diagram of a child safety seat according to a third embodiment of the present disclosure.

### DETAILED DESCRIPTION

Note that the exemplary configuration described in each of the following embodiments is only an exemplary one of various configurations of the present disclosure and should not be construed as limiting. Rather, the exemplary configuration may be readily modified in various manners depending on a design choice or any other factor, as long as the effect of the present disclosure can be achieved.

### (1) First Embodiment

(1-1) Air Conditioning System Using Thermal Sensation Estimation Device

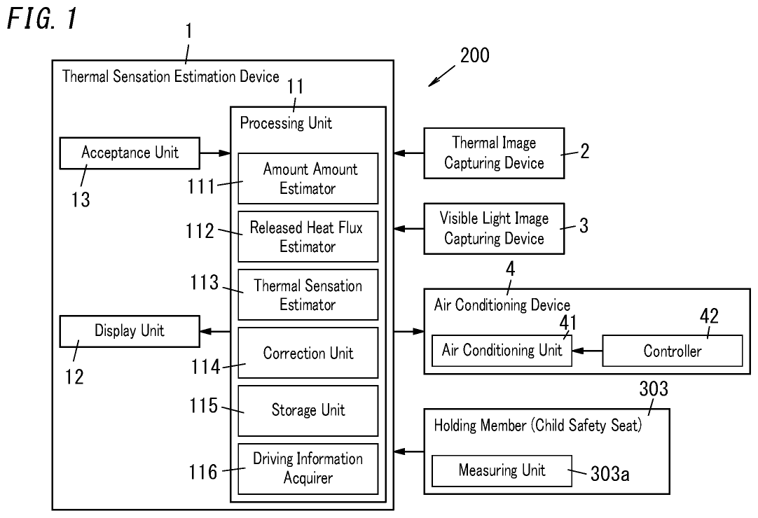

A thermal sensation estimation device 1 according to the first embodiment of the present disclosure realizes, in cooperation with a thermal image capturing device 2, a visible light image capturing device 3 and an air conditioning device 4, an air conditioning system 200 as shown in FIG. 1.

The thermal sensation estimation device 1 is wired or wirelessly connected to each of the thermal image capturing device 2, the visible light image capturing device 3, and the air conditioning device 4 to perform communication with each of them. The connection between the components of the air conditioning system 200 may be, for example, a connection by means of a communication cable, a connection by means of a short-range radio such as Bluetooth (registered trademark), or a connection through a network such as a LAN, the Internet, or a telephone network.

The thermal sensation estimation device 1 is configured to estimate thermal sensation of a user using the air conditioning system 200.

The thermal sensation estimation device 1 includes a processor and a memory. The memory stores therein a program(s) and various information. The function (thermal sensation estimation function) of the thermal sensation estimation device 1 is realized by the processor operating based on the program and various information stored in the memory. The programs and various information will be described later. The processor and the memory for realizing the thermal sensation estimation function may be referred to as a “computer.”

The thermal sensation estimation device 1 according to the present first embodiment further includes an input device, such as a touch panel or a keyboard, and an output device, such as a display or a speaker. The thermal sensation estimation device 1 may further include a communication module for performing at least one of short-range radio communication or network communication.

The thermal sensation estimation device 1 may be implemented as a dedicated apparatus, or may be incorporated into the air conditioning device 4 (air conditioner), a car navigation system, or an apparatus such as a holding member 303 (child safety seat 303).

The thermal image capturing device 2 is configured to capture (acquire) a thermal image. The thermal image according to the present first embodiment is an image of a user, captured with infrared rays. The image captured with infrared rays is an image in which the intensity distribution of infrared radiation energy emitted by the user is applied to contrast or color pattern. The infrared rays, for example, are preferably near infrared rays, but may be mid-infrared or far-infrared rays. That is to say, the wavelength of the infrared rays is not limited in particular.

The thermal image capturing device 2 is disposed in a position to capture the user. In the present first embodiment, the thermal image capturing device 2 is implemented as a stationary thermal camera (i.e., a thermography camera), but may be implemented as a mobile terminal, such as a smartphone or a tablet terminal, having an infrared camera module. The thermal camera (or the infrared camera module) captures (acquires) a two-dimensional thermal image of the user with the infrared rays.

The visible light image capturing device 3 captures (acquires) a visible light image. The visible light image according to the present first embodiment is an image of a space where the user is present, captured with visible rays (visible light). The visible light image capturing device 3 is disposed in a position to capture the space where the user is present. The visible light image capturing device 3 is, for example, a stationary camera, such as a camera of a drive recorder system or a surveillance camera, or may be a built-in camera of a mobile terminal.

The air conditioning device 4 is disposed in the space where the user is present (e.g., a car interior, a room, etc.) to perform air conditioning. The air conditioning includes adjusting at least one of an air temperature or a wind speed. The air conditioning may include adjusting all the air temperature, a humidity, and the wind speed. The air conditioning device 4 is implemented as, for example, an air conditioner, an electric fan, or the like.

The air conditioning device 4 includes a processor and a memory. The memory stores therein a program(s) and various information. The control function (air conditioning control function) of the air conditioning device 4 is realized by the processor operating based on the program and various information stored in the memory. The processor and the memory for realizing the air conditioning control function may be referred to as a “computer.”

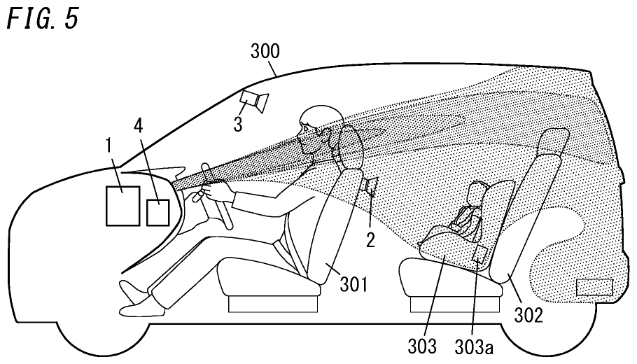

The air conditioning system 200 is installed in, for example, an interior of a car 300 as shown in FIG. 5. One or more occupants may be present in the interior. In the present first embodiment, two or more occupants are assumed to be in the car 300. One of the occupants is a user (hereinafter, referred to as a “driver”), who sits in the driver's seat 301 of the car 300 and drives the car 300. The other one of the occupants is a user (hereinafter, referred to as an “estimation target”), who is subjected to the estimation of the thermal sensation by the thermal sensation estimation device 1.

It is preferable that the estimation target belongs to an age period representing a relatively high correlation between height and age. Such as an age period is particularly an infancy. The infancy is an age period from 0 years old to a preschool age (5 or 6 years old). Accordingly, the estimation target in the present first embodiment is assumed to be, for example, an infant. However, the age period (representing the high correlation between height and age) may include a certain time period after school (e.g., a first grader period and/or a second grader period). Therefore, the estimation target may be a child in the lower grades of elementary school (6 to 8 years old). The age period of the estimation target is not limited to the infancy and/or the certain time period after school (e.g., from 0 years old to around 7 years old), as long as it represents a relatively high correlation between height and age. That is to say, the range of the age period should not be construed as limiting.

In the present first embodiment, a holding member 303 is attached to the rear seat 302 in the car 300, and the estimation target is held by the holding member 303. The holding member 303 is a member to hold the user. The holding member 303 may be, for example, a child safety seat 303 for infant or a junior seat for child.

The holding member 303 according to the present first embodiment includes a measuring unit 303a. The measuring unit 303a is configured to perform various types of measurements on the user held by the holding member 303. The various types of measurements include, for example, measurements of a body temperature, a heart rate, alpha waves, and a height (body height).

The measuring unit 303a in this embodiment includes a pressure sensor for measuring the body height. The pressure sensor is, for example, a sheet-like pressure sensor, and configured to measure (detect) a distribution of pressures applied to a surface (in contact with the user), of the holding member 303.

Preferably, the measuring unit 303a further includes one or more of the following sensors: a temperature sensor for measuring a body temperature, a heart rate sensor for measuring a heart rate, an acceleration sensor for measuring an active state, and a brain wave sensor for measuring brain waves (such as alpha waves).

However, the holding member 303 may not include the measuring unit 303a. Also, no holding member 303 may be provided, and the estimation target may be laid or seated on the rear seat 302. In this case, the measuring unit 303a may be provided to the rear seat 302.

(1-2) Thermal Sensation Estimation Device

As shown in FIG. 1, the thermal sensation estimation device 1 includes a processing unit 11, a display unit 12, and an acceptance unit 13.

The processing unit 11 performs various types of processing. The various types of processing are to be performed by a metabolic amount estimator 111, a released heat flux estimator 112, a thermal sensation estimator 113, a correction unit 114, a storage unit 115, and a driving information acquirer 116 (their details will be described later). The processing unit 11 also performs various determinations and the like, described in the flowcharts. The other processing will be described in a timely manner.

The display unit 12 displays various types of information. The various types of information include, for example, the visible light image described above, the thermal sensation information described later, height and age information described later, and the like.

The acceptance unit 13 accepts various types of operations. The various types of operations include, for example, a correctional operation and a display operation, described later.

The processing unit 11 includes the metabolic amount estimator 111, the released heat flux estimator 112, the thermal sensation estimator 113, the correction unit 114, the storage unit 115, and the driving information acquirer 116. However, the correction unit 114, the storage unit 115, and the driving information acquirer 116 are not mandatory, and the processing unit 11 may not include one or more of these elements.

The metabolic amount estimator 111 is configured to estimate the metabolic amount of the user. The metabolic amount is an amount of heat required for human activity. The metabolic amount in the present first embodiment is an amount of heat per unit surface area, consumed by the body of the user per unit time (i.e., a metabolic rate).

In the present disclosure, “estimating” may mean, for example, obtaining a corresponding estimation value from a plurality of pre-prepared estimation values, using a data table, or calculating an estimation value, using an algorithm. Needless to say, in case of obtaining the corresponding estimation value using the data table, “corresponding” may mean not only that “two values match with each other,” but also that “two values are closest to each other” and that “a difference between two values is less than a threshold.” The algorithm may be a function or an algorithm utilizing artificial intelligence, such as machine learning.

The metabolic amount estimator 111 measures the height of the user to determine a metabolic amount estimation value based on the height measured. The method of measuring the height will be described in detail later. The metabolic amount estimation value is an estimation value of the metabolic amount. The metabolic amount estimation value may be a value experimentally or statistically determined, or a value calculated by a prescribed algorithm.

“Determining the metabolic amount estimation value based on the height measured” includes, for example, estimating the age of the user based on the height measured and then determining the metabolic amount estimation value based on the age estimated (as described later) but should not be construed as limiting. Alternatively, “determining the metabolic amount estimation value based on the height measured” may include determining the metabolic amount estimation value directly from the height without estimating the age.

In the latter case, for example, the thermal sensation estimation device 1 may store, in the memory thereof, first correspondence information on the correspondence between heights and metabolic amount estimation values. The first correspondence information may be implemented as, for example, a data table where a plurality of sets are pre-registered, each of which includes a pair of: a height and a corresponding metabolic amount estimation value but should not be construed as limiting. Alternatively, the first correspondence information may be implemented as an algorithm of outputting a corresponding metabolic amount estimation value in response to inputting a height. That is to say, the format of the first correspondence information is not limited in particular.

The heights registered preferably include heights (e.g., about 0.5 m to 1.2 m) during the age period (particularly infancy) representing the high correlation between height and age but should not be construed as limiting. The heights registered may include heights during an age period other than the infancy. These matters are applied also to second correspondence information described later.

The metabolic amount estimator 111 determines (finds) a metabolic amount estimation value paired with a height in the first correspondence information, which matches with or is closest to the height (height measurement value) measured.

The metabolic amount of the user, which belongs to the age period representing the high correlation between height and age, can be accurately estimated based on the height of the user. Thus, using the metabolic amount estimated based on the height can improve accuracy of the thermal sensation estimator 113 (described later) estimating the thermal sensation of the user.

The metabolic amount estimator 111 measures the height of the user, estimates the age of the user based on the height measured, and determines the metabolic amount estimation value based on the age estimated.

For example, the thermal sensation estimation device 1 stores, in the memory thereof, second correspondence information on the correspondence between heights and age estimation values (that are estimation values of ages); and third correspondence information on the correspondence between ages and metabolic amount estimation values. The second correspondence information may be implemented as, for example, a data table where a plurality of sets are pre-registered, each of which includes a pair of: a height and a corresponding age estimation value but should not be construed as limiting. Alternatively, the second correspondence information may be implemented as an algorithm of outputting a corresponding age estimation value in response to inputting a height. That is to say, the format of the second correspondence information is not limited in particular.

The third correspondence information may be implemented as, for example, a data table where a plurality of sets are pre-registered, each of which includes a pair of: an age and a corresponding metabolic amount estimation value but should not be construed as limiting. Alternatively, the third correspondence information may be implemented as an algorithm of outputting a corresponding metabolic amount estimation value in response to inputting an age. That is to say, the format of the third correspondence information is not limited in particular. The ages registered preferably include ages belonging to the age period (e.g., from 0 years old to around 7 years old) representing the high correlation with height but should not be construed as limiting. The ages registered may include ages other than the age period.

The metabolic amount estimator 111 first obtain, from the second correspondence information, an age estimation value paired with the height (height measurement value) measured, and then determines a metabolic amount estimation value paired with an age in the third correspondence information, which matches with or is closest to the age estimation value obtained.

When the correction to the age estimation value by the correction unit 114 (described later) is received, the metabolic amount estimation value is determined based on the age corrected instead of the age estimation value registered.

The metabolic amount estimator 111 measures the height of the user based on the thermal image of the user, captured by the thermal image capturing device 2, for example.

Specifically, the thermal sensation estimation device 1 stores, in the memory thereof, information on the position and the angle of view, of the thermal image capturing device 2. The metabolic amount estimator 111 performs a contour detection (e.g., an edge detection) with respect to the thermal image captured, and extracts a thermal image in an area surrounded by a line (hereinafter, referred to as a “contour line”) along the contour thus detected. Thus, the metabolic amount estimator 111 obtains a thermal image within an area corresponding to the user's body. The metabolic amount estimator 111 measures the maximum diameter of the thermal image extracted, and converts a numerical value representing the maximum diameter measured (may be expressed in e.g., pixel number units) to a numerical value representing the height of the user (may be expressed in e.g., metric units), using the information on the position and the angle of view, stored in the memory.

Thus, the thermal sensation estimation device 1 can easily measure the height of the user by using the thermal image.

Alternatively, the height may be measured by using a visible light image. That is to say, the metabolic amount estimator 111 may measure the height of the user based on an image of the user, captured by the visible light image capturing device 3.

Alternatively, the height may be measured by using a near-infrared image. That is to say, the metabolic amount estimator 111 may measure the height of the user based on an image of the user, captured by a near-infrared image capturing device (not shown). The near-infrared image capturing device captures a two-dimensional near-infrared image using near-infrared rays.

Thus, the thermal sensation estimation device 1 can accurately measure the height of the user by using the visible light image or the near-infrared image.

Alternatively, the height may be measured by a method other than the image analysis as described above. The method other than the image analysis may be, for example, a method of measuring the height based on a distribution of pressures applied to a surface of the holding member 303.

Specifically, the metabolic amount estimator 111 may measure the distribution (pressure distribution) of pressures applied to the surface of the holding member 303, using a sheet-like pressure sensor provided to the measuring unit 303a, and binarize, by a prescribed threshold, the pressure distribution measured. The metabolic amount estimator 111 may obtain the contour line in the pressure distribution binarized, measure the maximum diameter of the contour line obtained and regard the measurement result (the maximum diameter) as the height of the user.

Thus, the thermal sensation estimation device 1 can easily measure the height of the user without using the image analysis.

The metabolic amount estimator 111 obtains the height and age information based on the height measured and the age estimated, and outputs the height and age information to the storage unit 115. The height and age information includes information on at least one of the height or the age. The height and age information includes, for example, information on both the height measured and the age estimated. The operation of the storage unit 115 will be described later.

The height and age information obtained may be output also to the display unit 12. The display unit 12 may display the height and age information received from the metabolic amount estimator 111. Thus, the user can easily recognize the height measured and the age estimated.

The released heat flux estimator 112 is configured to estimate a released heat flux. The released heat flux means a heat flux released outside from the user. The released heat flux in the present first embodiment is the amount of heat per unit area, which is released (lost) from the surface of the body of the user per unit time, where the unit of the amount of heat is “W/m².”

The released heat flux estimator 112 estimates the released heat flux, using the thermal image captured by the thermal image capturing device 2.

Specifically, the released heat flux estimator 112 first obtains, by using the thermal image, information on a surface temperature of a surface region of a part of the user's clothing (e.g., a part of the clothing covering the user's chest).

Next, the released heat flux estimator 112 estimates a clothing amount in a clothed portion (e.g., the chest) of the user's body, which is covered with the surface region described above. The clothing amount is information about a thermal resistance (thermal insulation) of the clothing worn by the user. The thermal resistance is a value to express the difficulty of thermal conduction.

The unit of the thermal resistance of the clothing is “Clo.” Note that, “1 Clo” is the clothing amount as comfortable for a person in a resting condition, seated in the interior with an air temperature of 21 degrees, a humidity of 50%, and an airflow of 0.1 m/seconds, and the thermal resistance is defined as 1 Clo=0.155 m²° C./W.

The clothing amount may be obtained, for example, as follows. That is to say, the thermal sensation estimation device 1 stores, in the memory thereof, information on the correspondence between dates, seasons and clothing amount estimation values. The released heat flux estimator 112 acquires time information from a clock of the processor, an NTP server, or any other server, acquires a season corresponding to the date included in the time information acquired, using the above-described information in the memory, and further acquires a clothing amount estimation value corresponding to the season.

Alternatively, the clothing amount may be estimated by the image analysis based on a visible light image of a space including the user, captured by the visible light image capturing device 3. Specifically, the thermal sensation estimation device 1 stores, in the memory thereof, information on the correspondence between types of clothing (e.g., coats, T-shirts, etc.) and clothing amount estimation values. The released heat flux estimator 112 estimates a type of clothing of the user by applying the image analysis with respect to the visible light image, and acquires a clothing amount estimation value corresponding to the type of clothing estimated, using the above-described information in the memory.

The released heat flux estimator 112 estimates the released heat flux based on the information on the surface temperature obtained and the clothing amount estimated.

The released heat flux estimator 112 may further estimate the skin temperature of the clothed portion (e.g., the chest) of the user's body and estimate the thermal sensation of the user by additionally using the skin temperature.

A skin temperature estimation value of the clothed portion may be obtained, for example, as follows. That is to say, the memory stores information about the correspondence between skin temperatures of a non-clothed portion (e.g., the head) and skin temperature estimation values of the clothed portion (the chest). The released heat flux estimator 112 measures the skin temperature of the non-clothed portion (the head) using the thermal image and acquires a skin temperature estimation value corresponding to the skin temperature measured, of the non-clothed portion (the head), using the information stored in the memory.

The released heat flux estimator 112 may estimate the released heat flux based on: the skin temperature (skin temperature estimation value) thus estimated, of the clothed portion (the chest); the surface temperature information obtained; and the clothing amount (clothing amount estimation value) estimated. The thermal sensation estimation device 1 therefore can improve the estimation accuracy of the released heat flux.

The method of estimating the released heat flux described above is merely one example and should not be construed as limiting.

The thermal sensation estimator 113 estimates the thermal sensation of the user based on the metabolic amount estimated by the metabolic amount estimator 111 and the released heat flux estimated by the released heat flux estimator 112.

The thermal sensation is information about the degree of warmth or coolness felt by the user. More specifically, for example, the thermal sensation is information such as “hot,” “warm,” “comfortable,” “cool,” and “cold,” but should not be construed as limiting.

In general, the thermal sensation of a person is considered to be “comfortable” when his/her released heat flux and metabolic amount are equal to each other. Accordingly, the thermal sensation estimation method according to the first embodiment of the present disclosure includes: subtracting the metabolic amount estimation value from a released heat flux estimation value; and estimating the thermal sensation based on the subtraction result thus obtained.

In other words, the thermal sensation estimator 113 estimates the thermal sensation of the user based on the subtraction result (hereinafter, referred to as a “released heat flux estimation value after subtraction”) obtained by subtracting the metabolic amount estimated (metabolic amount estimation value) from the released heat flux estimated (released heat flux estimation value).

For example, the thermal sensation estimation device 1 stores, in the memory thereof, a fourth correspondence information about the correspondence between: results of subtracting metabolic amounts from released heat fluxes (hereinafter, referred to as “released heat fluxes after subtraction”); and thermal sensation estimation values (which are estimation values of thermal sensation. The thermal sensation estimator 113 acquires, using the fourth correspondence information, a thermal sensation estimation value paired with a “released heat flux after subtraction,” which matches with or is closest to the “released heat flux estimation value after subtraction” obtained by the released heat flux estimator 112.

In this embodiment, the thermal sensation estimation device 1 performs the estimation of the thermal sensation using the metabolic amount estimated based on the height of the user, which can improve accuracy of estimating the thermal sensation.

In particular, for example, when the user (infant) is in an infancy, the thermal sensation estimation device 1 can estimate the thermal sensation of the infant by obtaining the metabolic amount, which greatly changes depending on age, based on the infant's height especially having a high correlation with respect to the infant's age. The thermal sensation estimation device 1 therefore can prevent the infant, who cannot say “hot/cold” well, from feeling discomfort or catching a cold.

Alternatively, the thermal sensation estimator 113 may estimate the thermal sensation of the user based on: the height measured based on the thermal image captured by the thermal image capturing device 2; and the released heat flux estimated based on the same thermal image captured.

Thus, the thermal sensation estimation device 1 uses the same thermal image for both the measurement of the height and the estimation of the released heat flux, which can simplify the configuration.

The correction unit 114 is configured to correct the height and age information displayed on the display unit 12 in accordance with a correctional operation received by the acceptance unit 13. The correctional operation is an operation to correct the information displayed. For example, if a certain numerical value in the height and age information displayed is different from an actual numerical value, the driver of the car may perform the correctional operation to correct the certain numerical value to the actual numerical value (correct numerical value) via an input device such as a touch panel.

When the acceptance unit 13 accepts the above-described correctional operation, the correction unit 114 also corrects the height and age information displayed.

The correctional operation is performed by the user or another user. The user is an estimation target, and in the present first embodiment is an infant. On the other hand, the other user is a user other than the estimation target, and in the present first embodiment is the driver of the car. Accordingly, the correctional operation is assumed to be, for example, performed by the driver.

Thus, the user or the other user can correct at least one of the height measured or the age estimated. The thermal sensation estimation device 1 therefore can improve accuracy of estimating the thermal sensation.

The storage unit 115 is configured to store, at predetermined time intervals, information about at least one of the height measured, or the age estimated. The storage destination of the information is assumed to be, for example, the memory of the thermal sensation estimation device 1 but should not be construed as limiting. Alternatively, the storage destination may be a memory of another device.

For example, when a predetermined storage condition is satisfied, the storage unit 115 stores the height and age information. The storage condition may be that a “predetermined time has elapsed since the previous storage.” The memory stores the height and age information with being associated with time information on the time when its storage is performed.

When the metabolic amount estimator 111 obtains new height and age information, the storage unit 115 acquires the time information indicating the current time from the built-in clock of the processor or the NTP server (not shown), and calculates a time difference between the time information acquired and the latest time information in the memory. The storage unit 115 performs the storage of the new height and age information when finding that the time difference calculated is more than the predetermined time.

Thus, the thermal sensation estimation device 1 can record the change in the height and/or the age of the user (e.g., the infant growth).

The height and age information stored is displayed, for example, in response to a display operation. The display operation is an instruction for displaying information.

Specifically, the display unit 12 is configured to display the height and age information stored by the storage unit 115, when the acceptance unit 13 accepts the display operation. The height and age information displayed may be the latest information stored, or two or more pieces of information (history information) stored in time series at the time when the display operation is received.

The driving information acquirer 116 is configured to acquire the driving information. The driving information is information about driving of the car 300. The driving information includes, for example, driving concentrate information and/or driving situation information.

The driving concentrate information relates to a degree of driving concentrate of the driver. The degree of driving concentrate is information indicating a degree to which the driver is concentrating on driving the car. The degree of driving concentrate may be estimated, for example, based on the direction of the driver's eyes (the line of sight).

The driving concentrate information includes, for example, a frequency at which the driver's eyes are directed toward the display unit 12 (e.g., the number of times the driver's eyes are directed toward the display unit 12 per unit time). The direction of the driver's eyes is determined based on the visible light image. The more frequency the driver's eyes are directed toward the display unit 12, the lower the degree of driving concentrate is estimated.

The driving situation information relates to a driving situation of the car 300. The driving situation information according to the present first embodiment includes speed information indicating the speed of the car 300. The driving situation information may include information indicating, for example, a frequency of brake operation, an operation amount of the handle per unit time, and a stability of movement of the car 300 (e.g., a detection frequency of an acceleration or a deceleration exceeding a threshold value). The driving situation information may be obtained based on information received from a computer system provided to the car 300.

Thus, the driving information acquired by the driving information acquirer 116 is output to the display unit 12.

The display unit 12 displays the thermal sensation information for an occupant (infant) on the rear seat 302 (based on the thermal sensation estimation value obtained by the thermal sensation estimator 113) with being superimposed on an image of the occupant captured by the visible light image capturing device 3.

The thermal sensation information relates to the thermal sensation of the user. The thermal sensation information may include the thermal sensation estimation value, or an image in a display form corresponding to the thermal sensation estimation value. The “image in the display form corresponding to the thermal sensation estimation value” may be, for example, an image colored with a color corresponding to the thermal sensation estimation value. The display form is not limited to color. Alternatively, the display form may be shading (brightness), hatching pattern, or line type (a thick line, a thin line, a broken line, a solid line, etc.).

For example, the “superimposing” process according to the present first embodiment includes: multiplying, by a first coefficient k1, a part corresponding to the thermal sensation information, in the image of the occupant captured; multiplying, by a second coefficient k2, the image of the thermal sensation information; and summing two results obtained by those multiplications (where, for example, 0≤k1≤1, 0≤k2≤1, k1+k2=1).

Thus, the thermal sensation estimation device 1 can present to the driver of the car 300 the visible light image of the occupant on the rear seat 302 along with the thermal sensation of the occupant.

The thermal sensation information superimposed is a silhouette image covering an area corresponding to the occupant in the image of the occupant captured. The silhouette image is changed in color in accordance with the thermal sensation.

In the present first embodiment, the original image before the silhouette image is generated is the visible light image. Alternatively, the original image may be the thermal image. The area corresponding to the occupant in the image is an area determined as a human image (region) by the contour detection or any other detection being performed to the image.

Specifically, for example, the processing unit 11 performs the contour detection to the visible light image captured by the visible light image capturing device. The processing unit 11 then determines whether or not an image within an area surrounded by a contour line along the contour thus detected has human characteristics. When determining that the image within the area has the human characteristics, the processing unit 11 decides that the image within the area is the human image.

Alternatively, the processing unit 11 may perform the contour detection to the thermal image, and decide, as the human image, a thermal image within an area surrounded by a contour line along the contour detected.

The display unit 12 generates a monochromatic (e.g., green) image (a silhouette image) having a shape corresponding to the area decided to be the human image. The display unit 12 changes the color of the silhouette image thus generated to a color corresponding to the thermal sensation estimation value obtained (e.g., blue when it is “cold,” green when it is “comfortable,” red when it is “hot”).

When a change condition is satisfied, the display unit 12 changes an extent of superimposition to which the silhouette image is superimposed on the image of the occupant captured, and displays the silhouette image at the extent of superimposition changed.

The change condition is a condition for changing the extent of superimposition. The change condition relates to, for example, the degree of driving concentrate of the driver. Alternatively, the change condition may relate to the driving situation of the car 300.

Specifically, the display unit 12 changes, in accordance with the degree of driving concentrate of the driver, the extent of superimposition to which the silhouette image is superimposed on the image of the occupant captured and displays the silhouette image at the extent of superimposition changed. For example, the lower the degree of driving concentrate, the lower the transmittance of the silhouette image (e.g., decreasing the first coefficient k1 while increasing the second coefficient k2).

The target to which the silhouette image is superimposed is assumed to be a visible light image. Alternatively, the target may be a near-infrared image.

The extent of superimposition means a degree to which the visible light image (or the near infrared image; the same shall apply hereinafter) (on which the silhouette image is superimposed) is visible through the silhouette image. The extent of superimposition may be therefore referred to as the transmittance of the visible light image to the silhouette image. The extent of superimposition may be changed, for example, depending on the coefficients by which the visible light image and the silhouette image are respectively multiplied.

Specifically, the display unit 12 changes the coefficients (by which the visible light image and the silhouette image are respectively multiplied) in accordance with the driving concentrate information acquired by the driving information acquirer 116. More specifically, for example, predetermined two thresholds (first and second thresholds; the first threshold>the second threshold) are stored in the memory. If the driving concentrate information is equal to or more than the first threshold, the display unit 12 sets the first coefficient k1 to “0.75” and the second coefficient k2 to “0.25.”

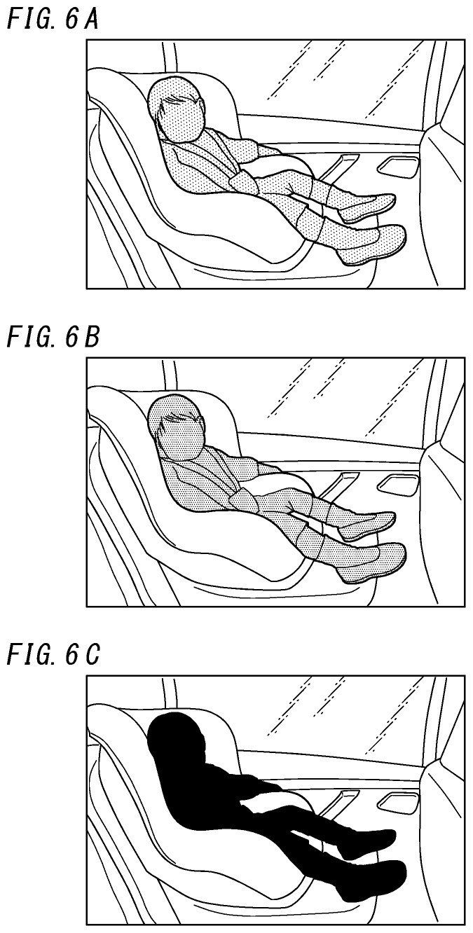

Thus, for example, as shown in FIG. 6A, the driver can easily visually recognize the condition of the occupant (infant) in the rear seat, as well as visually recognize the thermal sensation of the occupant.

If the driving concentrate information is equal to or more than the second threshold but less than the first threshold, the display unit 12 sets the first coefficient k1 (by which the visible light image is multiplied) to “0.5,” and the second coefficient k2 (by which the silhouette image is multiplied) to “0.5.”

Thus, for example, as shown in FIG. 6B, the transmittance of the silhouette image is set to be a half value. The visibility of the condition of the occupant is therefore reduced.

If the driving concentrate information is less than the second threshold, the display unit 12 sets the first coefficient k1 (by which the visible light image is multiplied) to “0,” and the second coefficient k2 (by which the silhouette image is multiplied) to “1.”

Accordingly, for example, as shown in FIG. 6C, the transmittance of the silhouette image is set to be zero. The occupant is therefore made invisible.

Thus, the thermal sensation estimation device 1 can present to the driver of the car 300 the visible light image of the user to be easily visually recognized even when the driver is concentrating on driving.

Also, the display unit 12 changes the extent of superimposition based on the driving situation of the car 300, and displays the silhouette image at the extent of superimposition changed.

Specifically, for example, predetermined two thresholds (third and fourth thresholds; the third threshold<the fourth threshold) are stored in the memory. For example, if the speed information included in the driving situation information exceeds the third threshold, the display unit 12 sets the transmittance of the silhouette image to a half value. The image area of the occupant included in the visible light image is accordingly covered with the translucent silhouette image, making it difficult to be visually recognized.

For example, if the speed information included in the driving situation information exceeds the fourth threshold, the display unit 12 sets the transmittance of the silhouette image to zero. The image area of the occupant included in the visible light image is accordingly covered with the opaque silhouette image, making it invisible.

Thus, the thermal sensation estimation device 1 can present to the driver of the car 300 the visible light image of the user to be easily visually recognized when the burden of driving is relatively small.

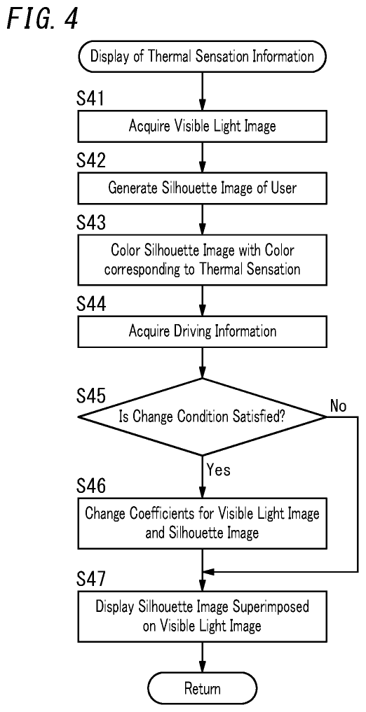

The operation of changing the “extent of superimposition” in the display unit 12 described above may be performed as follows. That is to say, the processing unit 11 may determine, based on the driving information, whether or not the change condition is satisfied, as described in the flowchart of FIG. 4. When determining that the change condition is satisfied, the processing unit 11 may perform the operation of changing the “extent of superimposition.”

(1-3) Operation of Thermal Sensation Estimation Device

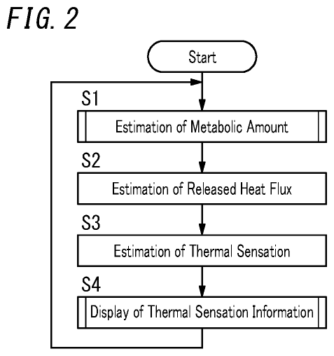

Hereinafter, the operation of the thermal sensation estimation device 1 constituting the air conditioning system 200 shown in FIG. 1 will be described with reference to the flowcharts shown in FIGS. 2 to 4. In the following description, the user is assumed to be an estimation target of the thermal sensation estimation device 1 and especially an infant. The other user is assumed to be a user other than the estimation target and especially a driver.

The processing of the flowcharts shown in FIGS. 2 to 4 is started in response to that the power of the thermal sensation estimation device 1 is turned on, and ended in response to that the power is turned off.

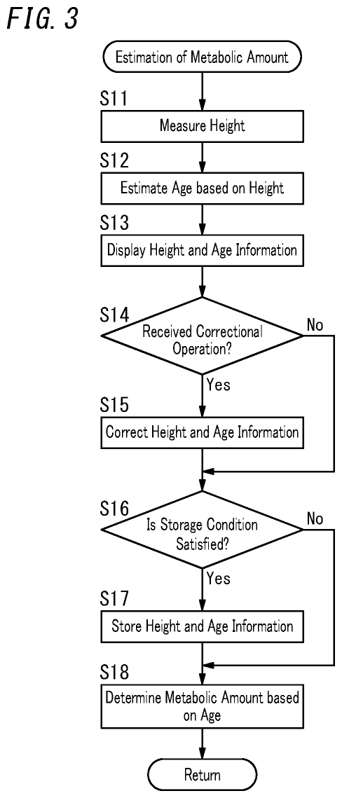

When the processing is started, the metabolic amount estimator 111 estimates the metabolic amount of the user to obtain the metabolic amount estimation value (in Step S1). The metabolic amount estimation processing in Step S1 will be described later, using the flowchart of FIG. 3.

Next, the released heat flux estimator 112 estimates the released heat flux of the user based on the thermal image of the user captured by the thermal image capturing device 2 and any other factor to obtain the released heat flux estimation value (in Step S2). The explanation of the method for estimating the released heat flux is omitted since it has been described above.

Next, the thermal sensation estimator 113 estimates the thermal sensation of the user based on the metabolic amount estimated in Step S1 and the released heat flux estimated in Step S2 to obtain the thermal sensation estimation value (in Step S3).

Specifically, the thermal sensation estimator 113 subtracts the metabolic amount estimation value from the released heat flux estimation value and obtains the subtraction result (the released heat flux estimation value after subtraction). The thermal sensation estimator 113 acquires a thermal sensation estimation value paired with a “released heat flux after subtraction,” which matches with or is closest to the subtraction result, using the fourth correspondence information stored in the memory.

Next, in Step S4, the display unit 12 displays the thermal sensation information based on the thermal sensation estimation value acquired in Step S3. Then, the processing returns to Step S1. Note that, the thermal sensation information display processing in Step S4 will be described later, using the flowchart shown in FIG. 4.

The metabolic amount estimation processing in Step S1 described above is performed, for example, according to the flowchart of FIG. 3.

The metabolic amount estimator 111 measures the height of the user, using the thermal image captured by the thermal image capturing device 2 (in Step S11). Next, in Step S12, the metabolic amount estimator 111 estimates the age of the user based on the height measured in Step S11. Specifically, the metabolic amount estimator 111 determines a metabolic amount estimation value paired with a height, which matches with or is closest to the height measured, using the first correspondence information stored in the memory.

Next, in Step S13, the metabolic amount estimator 111 causes the display unit 12 to display the height and age information including the height measured in Step S11 and the age estimated in Step S12. Next, in Step S14, the processing unit 11 determines whether or not the acceptance unit 13 has received the correctional operation. When it is determined that the acceptance unit 13 has not received the correctional operation, the processing proceeds to Step S16.

When it is determined that the acceptance unit 13 has received the correctional operation, the correction unit 114 corrects the height and age information (in Step S15). Next, the storage unit 115 determines whether or not the storage condition is satisfied (in Step S16). Specifically, the storage condition is that the “predetermined time has elapsed since the previous storage.” The memory stores therein the height and age information with being associated with the time information about the time the storage is performed. The storage unit 115 acquires the time information from the built-in clock and calculates the time difference from the latest time information stored in the memory. If the time difference calculated is more than the predetermined time, the storage unit 115 determines that the storage condition is satisfied and stores in the memory the height and age information (in Step S17).

Next, in Step S18, the metabolic amount estimator 111 estimates the metabolic amount (i.e., determines the metabolic amount estimation value) based on the age estimation value obtained in Step S12 or the age corrected in Step S15. Specifically, the metabolic amount estimator 111 determines a metabolic amount estimation value paired with an age, which matches with or is closest to the age estimation value obtained or the age corrected, using the third correspondence information stored in the memory. Thereafter, it returns to the high-order processing (in FIG. 2).

The thermal sensation information display processing in Step S4 described above is performed, for example, according to the flowchart of FIG. 4.

The display unit 12 acquires the visible light image of the interior, captured by the visible light image capturing device 3 (in Step S41). Next, in Step S42, the display unit 12 generates the silhouette image of the user based on the visible light image acquired in Step S41. The explanation of the method for generating the silhouette image is omitted since it has been described above.

Next, in Step S43, the display unit 12 colors the silhouette image generated in Step S42 with a color corresponding to the thermal sensation estimated in Step S3. Thus, the other user can visually recognize the thermal sensation of the user. The explanation of the method for coloring the silhouette image is omitted since it has been described above.

Next, in Step S44, the driving information acquirer 116 acquires the driving information based on the visible light image acquired in Step S41 and the information received from the computer system of the car 300. The explanation of the method for acquiring the driving information is omitted since it has been described above.

Next, in Step S45, the processing unit 11 determines whether or not the change condition is satisfied based on the driving information acquired in Step S44. The change condition may relate to, for example, the degree of driving concentrate of the driver, or the driving situation (speed, etc.) of the car 300. If it is determined that the change condition is not satisfied, the processing proceeds to step S47.

In Step S46, the display unit 12 changes the coefficients k1 and k2 for the visible light image and the silhouette image, when it is determined that the change condition is satisfied. In Step S47, the display unit 12 displays the silhouette image superimposed on the visible light image, using the coefficients k1 and k2 changed in Step S46. Thus, the silhouette image is superimposed on the visible light image at the extent (transparency) in accordance with the degree of driving concentrate of the driver or the driving situation of the car 300, which can prevent the visible light image of the user from interfering with the driving of the driver.

In the flowcharts of FIGS. 2 to 4, the silhouette image is colored with the color corresponding to the thermal sensation. Alternatively, the thermal sensation estimation value may be displayed in a form (e.g., a character, a mark or any other factor, representing the thermal sensation estimation value) other than the color of the silhouette image.

(1-4) Example of Operation of Air Conditioning System

The air conditioning system 200 in this example is applied to the car 300 to provide air conditioning of the interior, as shown in FIG. 5. The users of the air conditioning system 200 are two occupants of the car 300, one of whom is the driver and the other of whom is the infant. The driver sits on the driver's seat 301 at the front of the car 300 and drives the car 300. The infant is held by the holding member 303 (child safety seat 303) provided on the rear seat 302. The user that is the estimation target of the thermal sensation estimation device 1 is the infant on the rear seat 302.

The thermal sensation estimation device 1 and the air conditioning device 4 are provided to a dashboard of the interior, and perform the estimation of the thermal sensation and the air conditioning based on the estimation result, respectively. The thermal image capturing device 2 is disposed on the rear side of the driver's seat 301 (or passenger's seat), captures the image of the infant on the rear seat 302 using infrared rays, and transmits the thermal image including the image of the infant to the thermal sensation estimation device 1. The visible light image capturing device 3 is provided to a room mirror to capture the image of the interior with visible light, and transmits the visible light image including images of the driver and the infant to the thermal sensation estimation device 1. The holding member 303 on the rear seat 302 is provided with the measuring unit 303a including various sensors described above, and the measurement result of the measuring unit 303a is transmitted from the holding member 303 to the thermal sensation estimation device 1.

When the thermal sensation estimation device 1 is activated while the car 300 is stopped, the metabolic amount estimator 111 measures the height of the infant, using the thermal image captured by the thermal image capturing device 2, and estimates the age of the infant based on the height. Then, the thermal sensation estimation device 1 acquires the height and age information including the height measured and the age estimated to output it to the display unit 12.

The memory of the thermal sensation estimation device 1 stores: history information including a plurality of pieces of the height and age information acquired in the past; and screen generation information for generating a screen. The screen generation information includes images such as button icons, text information such as “Correct” and layout information relating to their layouts.

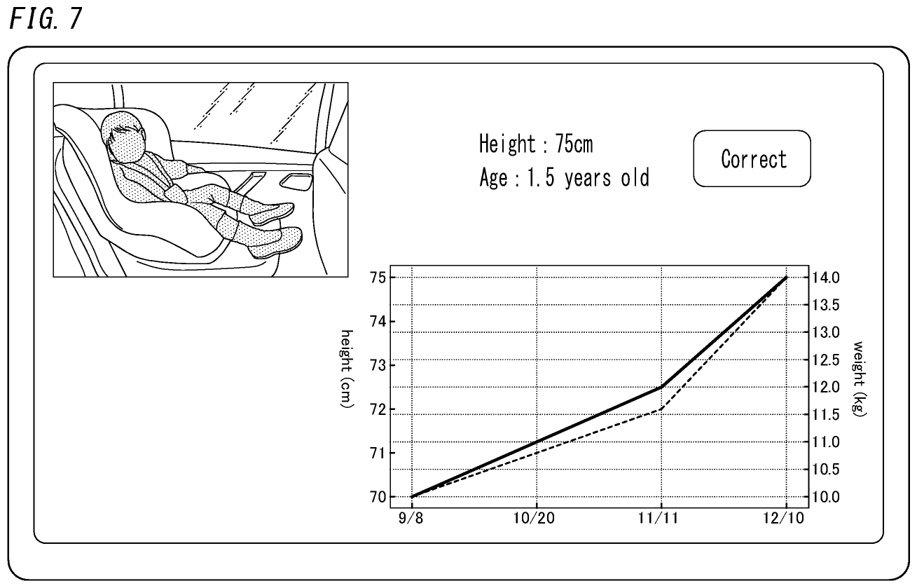

The processing unit 11 generates, for example, a screen as shown in FIG. 7, using the height and age information acquired, the history information and screen generation information stored in the memory, and the visible light image captured by the visible light image capturing device 3, and outputs the screen to the display unit 12. The display unit 12 displays the screen on a display.

The screen of FIG. 7 includes the visible light image of the infant, the height and age information (Height: 75 cm, Age: 1.5 years old), a “Correct” button, and a growth record of the infant. The growth record has the form of a line graph, where a horizontal axis represents date; and right and left vertical axes respectively represent weight and height. Regarding the growth record, numerical values of those axes and two lines are generated based on the history information stored in the memory and the height and age information acquired.

When the “Correct” button is touched on the screen of the display, the correctional operation for correcting the height and age information (Height: 75 cm, Age: 1.5 years old) is enabled. When the correctional operation is performed, the acceptance unit 13 accepts the correctional operation, and the correction unit 114 corrects the height and age information in response to the correctional operation.

The storage unit 115 determines whether or not the storage condition: the “predetermined time has elapsed since the previous storage” is satisfied. When determining that the storage condition is satisfied, the storage unit 115 stores, in the memory, the height and age information acquired, or the height and age information corrected.

The metabolic amount estimator 111 estimates the metabolic amount (i.e., determines the metabolic amount estimation value) based on the age estimation value included in the height and age information acquired, or the age corrected. Then, the released heat flux estimator 112 estimates the released heat flux of the infant based on the thermal image captured by the thermal image capturing device 2 or the like. Then, the thermal sensation estimator 113 estimates the thermal sensation of the infant based on the metabolic amount estimated and the released heat flux estimated.

As the car 300 begins to move, the processing is performed according to the flowchart of FIG. 4. Accordingly, instead of the screen in FIG. 5, any of the screens as shown in FIGS. 6A to 6C is displayed on the display, which includes the visible light image and the thermal sensation information based on the thermal sensation estimated.

In each of the screens shown in FIGS. 6A to 6C, the silhouette image is disposed in the area corresponding to the infant in the visible light image, and colored with a color corresponding to the thermal sensation estimation value included in the thermal sensation information, and superimposed at the extent corresponding to at least one of the degree of driving concentrate of the driver or the driving situation of the car 300.

In this example, it is assumed that the thermal sensation estimation device 1 obtains the thermal sensation estimation value: “comfortable.”. In this case, the silhouette image is colored with green corresponding to the thermal sensation estimation value: “comfortable.” Thus, even in any of the screens shown in FIGS. 6A to 6C, the color of the silhouette image is green.

However, in the screens shown in FIGS. 6A to 6C, the transmittances of the silhouette images are different from each other. The respective transmissions of the silhouette images in the screens shown in FIGS. 6A to 6C are 75%, 50% and 0%.

In this example, the extent of superimposition is assumed to be changed according to the degree of driving concentrate of the driver. When the degree of driving concentrate is relatively high, the screen shown in FIG. 6A is displayed such that the image of the infant is visually recognized well. When the degree of driving concentrate is slightly reduced, the screen shown in FIG. 6A is switched to the screen shown in FIG. 6B to make it difficult to visually recognize the image of the infant. When the degree of driving concentrate is further reduced, the screen shown in FIG. 6B is switched to the screen shown in FIG. 6C to completely obscure the image of the infant.

In case that the extent of superimposition is changed according to the driving situation of the car 300 (here, speed), when the speed of the car 300 is relatively low, the screen shown in FIG. 6A (where the image of the infant is visually recognized well) is displayed. When the speed of the car 300 is slightly increased, the screen shown in FIG. 6A is switched to the screen shown in FIG. 6B to make it difficult to visually recognize the image of the infant. When the speed of the car 300 is further increased, the screen shown in FIG. 6B is switched to the screen shown in FIG. 6C to completely obscure the image of the infant.

Alternatively, the driver may manually select which of the degree of driving concentrate and the driving situation of the car 300 the extent of superimposition is changed according to (i.e., the driver may manually select any one from operation modes relating to the superimposition). When the driver selects any one from the operation modes, the acceptance unit 13 accepts the selection operation, and the display unit 12 may perform the superimposition according to the one mode selected.

Thus, the driver can visually recognize the thermal sensation of the infant present in the rear seat 302.

The display unit 12 may also display various information other than the thermal sensation. The various information may be, for example, information measured by the measuring unit 303a or information obtained based on the information thus measured. Specifically, examples of the various information include information such as a body temperature, a heart rate, an active state, and a comfort level. The information on the body temperature is a measuring value measured by a temperature sensor. The information on the heart rate is a measuring value measured by a heart rate sensor. The information on the active state is obtained based on a waveform of an acceleration detected by an acceleration sensor or the like. The heart rate may also be obtained from the waveform of the acceleration, and in that case, the heart rate sensor is not required.

The information on the active state includes information representing whether a person is awakening or sleeping. For example, the processing unit 11 integrates the waveform of the acceleration detected by the acceleration sensor over a unit time, and acquires an activity amount corresponding to the integration result. The processing unit 11 may determine whether the person is awakening or sleeping based on the activity amount acquired (for example, by comparing the activity amount acquired with a predetermined fifth threshold) and obtain the information on the active state, including the determination result.

When the active state is “sleeping” (i.e., the activity amount is equal to or more than the fifth threshold), the information on the active state may further include information on a depth of sleep (sleep level). For example, the processing unit 11 may estimate the depth of sleep based on the activity amount and the detection result (such as waveforms of alpha waves) of the brain wave sensor, and acquires the information on the active state, including the estimation result of the depth.

When the active state is “awakening” (i.e., the activity amount is less than the fifth threshold), the information on the active state may further include information on activeness. The information on activeness may be, for example, information representing active or quiet. For example, the processing unit 11 compares the activity amount with a predetermined sixth threshold (>the fifth threshold) to determine whether the person is active or quiet, and acquires the information on the active state, including the determination result.

The display unit 12 displays the various information thus obtained. The driver can therefore know not only the thermal sensation of the infant in the rear seat 302, but also the physical and psychological condition of the infant.

Hereinafter, the function of the processing unit 11 of: estimating the active state of the user (the occupant in the rear seat 302); and acquiring the information including the estimation result is referred to as an “active state estimation function.” The processing unit 11 having the active state estimation function may be referred to as an “active state estimator 11.”

The metabolic amount estimator 111 may correct the metabolic amount (estimated as described above) in accordance with the active state estimated by the processing unit 11 (active state estimator 11).

Specifically, for example, the metabolic amount estimator 111 corrects the metabolic amount (estimated as described above) to be reduced, when the active state estimated by the processing unit 11 is “sleeping” (for example, when the activity amount is equal to or less than the fifth threshold). On the other hand, the metabolic amount estimator 111 corrects the metabolic amount (estimated as described above) to be increased, when the active state estimated is “active” (for example, when the activity amount is equal to or more than the sixth threshold).

Thus, the thermal sensation estimation device 1 can further improve accuracy of estimating the thermal sensation.

The thermal sensation estimated by the thermal sensation estimation device 1 (the thermal sensation estimation value obtained by the thermal sensation estimator 113) is transmitted to the air conditioning device 4. In the air conditioning device 4, the air conditioning unit 41 performs air conditioning (adjusting an air temperature and a wind speed in this example) based on the condition of the air inside the interior (the air temperature and the wind speed in this example) previously set by the user.

For example, the memory of the air conditioning device 4 stores therein a fifth correspondence information about the correspondence between two or more thermal sensations and two or more pairs of air temperatures and wind speeds. The controller 42 acquires a pair of an air temperature and a wind speed corresponding to a thermal sensation, which matches with or is closest to the thermal sensation estimation value received from the thermal sensation estimation device 1, using the fifth correspondence information. The controller 42 controls the air conditioning unit 41 based on the pair of the air temperature and the wind speed acquired.

For example, if the thermal sensation estimation value is “cold,” the controller 42 controls the air conditioning unit 41 to change the air temperature and the wind speed in the interior to be made higher than the set values. If the thermal sensation estimation value is “slightly cold,” the controller 42 controls the air conditioning unit 41 to change the air temperature in the interior to be made higher than the set value, while keeping the current wind speed.

If the thermal sensation estimation value is “comfortable,” the controller 42 controls the air conditioning unit 41 to keep the current air temperature and wind speed. If the thermal sensation estimation value is “slightly hot,” the controller 42 controls the air conditioning unit 41 to change the air temperature in the interior to be made lower than the set value, while keeping the current wind speed. If the thermal sensation estimation value is “hot,” the controller 42 controls the air conditioning unit 41 to change the air temperature in the interior to be made lower than the set value but change the wind speed in the interior to be made higher than the set value.

Accordingly, the air conditioning system 200 can perform comfortably air conditioning for the infant in the rear seat 302 of the car 300 based on the thermal sensation estimated based on the height.

### (2) Second Embodiment

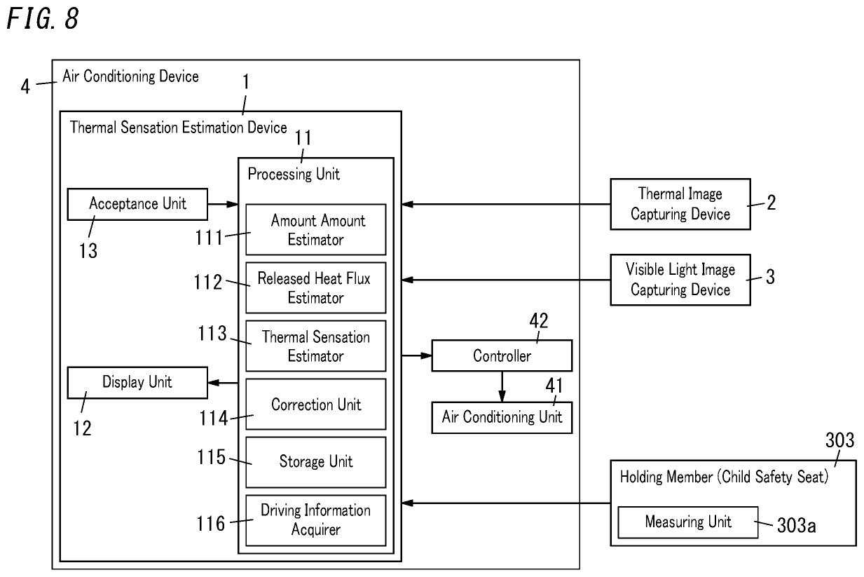

The second embodiment is an embodiment of an air conditioning device of the present disclosure. As shown in FIG. 8, an air conditioning device 4 according to the second embodiment includes a thermal sensation estimation device 1, an air conditioning unit 41, and a controller 42. The thermal sensation estimation device 1 according to the second embodiment has substantially the same configuration as the thermal sensation estimation device 1 according to the first embodiment. The air conditioning unit 41 and the controller 42 perform substantially the same operations as those of the first embodiment.

According to the second embodiment, the air conditioning device 4 can perform the comfortable air conditioning for the user based on the thermal sensation estimated from the height of the user.

### (3) Third Embodiment

The third embodiment is an embodiment of a child safety seat of the present disclosure. A child safety seat 303 according to the third embodiment is installed to a rear seat 302 in a car 300 to hold an infant, similarly to the child safety seat 303 according to the first embodiment.

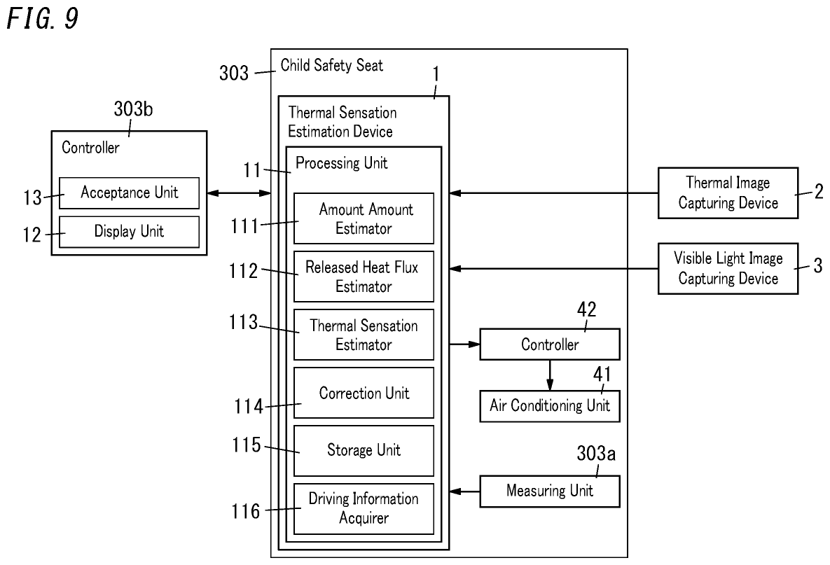

As shown in FIG. 9, the child safety seat 303 according to the third embodiment includes a thermal sensation estimation device 1, an air conditioning unit 41, a controller 42, and a measuring unit 303a.

The thermal sensation estimation device 1 according to the third embodiment estimates the thermal sensation of the infant held by the child safety seat 303 in the rear seat 302 of the car 300.

The thermal sensation estimation device 1 according to the third embodiment has substantially the same configuration as the thermal sensation estimation device 1 according to the first embodiment. However, a display unit 12 and an acceptance unit 13 in the third embodiment are installed to a controller 303b provided separately from the child safety seat 303. The controller 303b is provided at a position (e.g., a dashboard) where the driver of the car 300 can visually recognize and operate it. The controller 303b is configured to communicate with the thermal sensation estimation device 1 by a wired method or wirelessly.

The controller 303b may be implemented as a dedicated terminal, may be incorporated into an operation panel of an air conditioner or a car navigation system installed in car, or may be implemented by installing a predetermined application software to a mobile terminal such as a smartphone.

The air conditioning unit 41 according to the present third embodiment is implemented as, for example, a fan. The fan may be secured integrally to the child safety seat 303, or provided separately from the child safety seat 303. The air conditioning unit 41 is not limited to the fan but may be implemented as an air conditioner of the car 300.

The controller 42 controls the air conditioning device based on the thermal sensation of the infant estimated by the thermal sensation estimation device 1.

For example, the controller 42 controls the wind speed of the wind blown by the fan based on the thermal sensation estimation value of the infant obtained by the thermal sensation estimation device 1. If the wind direction of the fan is also adjustable, the controller 42 may control adjusting the wind speed and the wind direction based on the thermal sensation estimation value.

Thus, the child safety seat 303 can hold the infant in the rear seat 302 of the car 300, while providing the air conditioning in accordance with the thermal sensation of the infant.

The function similar to the thermal sensation estimation device 1 according to the first embodiment described above may be realized by a thermal sensation estimation method, a (computer) program, a non-transitory storage medium storing the program, or the like. The thermal sensation estimation method includes at least Step S1 (the step of obtaining the metabolic amount), Step S2 (the step of estimating the released heat flux), and Step S3 (the step of estimating the thermal sensation), of the various steps described above. The step of estimating the metabolic amount includes: measuring the height of the user; and determining the metabolic amount estimation value based on the height. The program is designed to cause one or more processors to perform the thermal sensation estimation method.

### (4) Recapitulation

A thermal sensation estimation device (1) according to a first aspect includes a metabolic amount estimator (111), a released heat flux estimator (112), and a thermal sensation estimator (113). The metabolic amount estimator (111) is configured to estimate a metabolic amount of a user. The released heat flux estimator (112) is configured to estimate a released heat flux as a heat flux released outside from the user. The thermal sensation estimator (113) is configured to estimate thermal sensation of the user based on the metabolic amount and the released heat flux. The metabolic amount estimator (111) is configured to measure a height of the user to estimate the metabolic amount based on the height measured.

According to this aspect, the metabolic amount of the user is obtained based on the height of the user. The thermal sensation estimation device (1) therefore can contribute to improving accuracy of estimating the thermal sensation of the user.

In particular, for example, when the user (infant) is in an infancy, the thermal sensation estimation device can estimate the thermal sensation of the infant by obtaining the metabolic amount, which greatly changes depending on age, based on the infant's height especially having a high correlation with respect to the infant's age. The thermal sensation estimation device (1) therefore can prevent the infant, who cannot say “hot/cold” well, from feeling discomfort or catching a cold.

In a thermal sensation estimation device (1) according to a second aspect, which may be implemented in conjunction with the first aspect, the metabolic amount estimator (111) is configured to estimate an age of the user based on the height to estimate the metabolic amount based on the age estimated.

According to this aspect, the age is estimated based on the height and the metabolic amount is estimated based on the age estimated. The thermal sensation estimation device (1) therefore can estimate the thermal sensation of the user with higher accuracy.

A thermal sensation estimation device (1) according to a third aspect, which may be implemented in conjunction with the second aspect, further includes a display unit (12). The display unit (12) is configured to display information about at least one of the height measured, or the age estimated.

According to this aspect, the thermal sensation estimation device (1) can realize that a person can easily recognize at least one of the height measured, or the age estimated.

A thermal sensation estimation device (1) according to a fourth aspect, which may be implemented in conjunction with the third aspect, further includes a correction unit (114). The correction unit (114) is configured to correct the information displayed on the display unit (12) in accordance with an operation by the user or another user.

According to this aspect, the thermal sensation estimation device (1) can realize that the user or the other user can correct at least one of the height measured, or the age estimated. The thermal sensation estimation device (1) therefore can estimate the thermal sensation of the user with higher accuracy.

A thermal sensation estimation device (1) according to a fifth aspect, which may be implemented in conjunction with the third or fourth aspect, further includes a storage unit (115). The storage unit (115) is configured to store, at predetermined time intervals, information about at least one of the height measured, or the age estimated. The display unit (12) is configured to display the information stored.

According to this aspect, the thermal sensation estimation device (1) can record change in the height and/or the age of the user (e.g., child growth).

In a thermal sensation estimation device (1) according to a sixth aspect, which may be implemented in conjunction with any one of the first to fifth aspects, the metabolic amount estimator (111) is configured to measure the height based on a thermal image of the user captured by a thermal image capturing device (2).

According to this aspect, the thermal sensation estimation device (1) can more easily measure the height of the user by using the thermal image.

In a thermal sensation estimation device (1) according to a seventh aspect, which may be implemented in conjunction with the sixth aspect, the released heat flux estimator (112) is configured to estimate the released heat flux based on the thermal image. The thermal sensation estimator (113) is configured to estimate the thermal sensation based on: the height measured based on the thermal image; and the released heat flux estimated based on the thermal image.

According to this aspect, the same thermal image is used for both measuring the height and estimating the released heat flux, which can simplify the configuration of the thermal sensation estimation device (1).

In a thermal sensation estimation device (1) according to an eighth aspect, which may be implemented in conjunction with any one of the first to fifth aspects, the metabolic amount estimator (111) is configured to measure the height based on an image of the user captured by a visible light image capturing device (3) or a near-infrared image capturing device (not shown).

According to this aspect, the thermal sensation estimation device (1) can obtain the height of the user with higher accuracy by using the visible light image or the near-infrared image.

In a thermal sensation estimation device (1) according to a ninth aspect, which may be implemented in conjunction with any one of the first to fifth aspects, the metabolic amount estimator (111) is configured to measure the height by using a measuring unit (303a) of a holding member holding the user.

According to this aspect, the thermal sensation estimation device (1) can directly measure the height of the user.

In a thermal sensation estimation device (1) according to a tenth aspect, which may be implemented in conjunction with the ninth aspect, the measuring unit (303a) includes a pressure sensor. The pressure sensor is configured to detect a distribution of pressures applied to a surface in contact with the user, of the holding member.

According to this aspect, the thermal sensation estimation device (1) can more easily measure the height of the user.

In a thermal sensation estimation device (1) according to an eleventh aspect, which may be implemented in conjunction with any one of the first to tenth aspects, the user is one occupant of a car (300).

According to this aspect, when the user is in the car (300), the thermal sensation estimation device (1) can estimate the thermal sensation of the user with higher accuracy.

A thermal sensation estimation device (1) according to a twelfth aspect, which may be implemented in conjunction with the eleventh aspect, further includes a display unit (12). The one occupant is present on a rear seat (302) in the car (300). The display unit (12) is configured to display, to a driver as another occupant of the car (300), thermal sensation information about the thermal sensation of the one occupant.

According to this aspect, the thermal sensation estimation device (1) can realize that the driver of the car (300) can know the thermal sensation of the one occupant present on the rear seat (302).

In a thermal sensation estimation device (1) according to a thirteenth aspect, which may be implemented in conjunction with the twelfth aspect, the display unit (12) is configured to display the thermal sensation information with being superimposed on an image of the one occupant captured by a visible light image capturing device (3).

According to this aspect, the thermal sensation estimation device (1) can present, to the driver of the car (300), the visible light image of the one occupant present on the rear seat (302) together with the thermal sensation information.

In a thermal sensation estimation device (1) according to a fourteenth aspect, which may be implemented in conjunction with the thirteenth aspect, the thermal sensation information is a silhouette image covering an area corresponding to the one occupant in the image of the one occupant captured, the silhouette image being changed in color in accordance with the thermal sensation. The display unit (12) is configured to change, in accordance with a degree of driving concentrate of the driver, an extent of superimposition to which the silhouette image is superimposed on the image of the one occupant captured, and display the thermal sensation information at the extent of superimposition changed.

According to this aspect, the thermal sensation estimation device (1) can present, to the driver of the car (300), the visible light image of the user so as to be easily visualized by the driver concentrating on driving.

In a thermal sensation estimation device (1) according to a fifteenth aspect, which may be implemented in conjunction with the fourteenth aspect, the display unit (12) is configured to change the extent of superimposition based on a driving situation of the car (300), and display the thermal sensation information at the extent of superimposition changed.

According to this aspect, the thermal sensation estimation device (1) can present, to the driver of the car (300), the visible light image of the user so as to be easily visualized by the driver when the burden of driving is determined to be relatively small.

A thermal sensation estimation device (1) according to a sixteenth aspect, which may be implemented in conjunction with any one of the first to fifteenth aspects, further includes an active state estimator (processing unit 11). The active state estimator (processing unit 11) is configured to estimate an active state of the user. The metabolic amount estimator (111) is configured to correct, in accordance with the active state, the metabolic amount estimated.

According to this aspect, the thermal sensation estimation device (1) can further improve accuracy of estimating the thermal sensation of the user.

In a thermal sensation estimation device (1) according to a seventeenth aspect, which may be implemented in conjunction with the sixteenth aspect, the active state includes a state selected from the group including awakening and sleeping.

According to this aspect, the thermal sensation estimation device (1) can further improve accuracy of estimating the thermal sensation of the user.

In a thermal sensation estimation device (1) according to an eighteen aspect, which may be implemented in conjunction with any one of the first to seventeenth aspects, the user belongs to an age period representing a relatively high correlation between height and age.

According to this aspect, obtaining the metabolic amount based on the height can improve accuracy of estimating the thermal sensation of the user belonging to the age period representing a relatively high correlation between height and age.

In a thermal sensation estimation device (1) according to a nineteen aspect, which may be implemented in conjunction with the eighteen aspect, the age period is an infancy.

According to this aspect, obtaining the metabolic amount based on the height can improve accuracy of estimating the thermal sensation of the user belonging to the infancy representing an especially high correlation between height and age.

An air conditioning device (4) according to a twentieth aspect includes: the thermal sensation estimation device (1) of any one of the first to nineteen aspects; an air conditioning unit (41); and a controller (42). The air conditioning unit (41) is configured to perform air conditioning. The controller (42) is configured to control the air conditioning unit (41) based on the thermal sensation of the user, estimated by the thermal sensation estimation device (1).

According to this aspect, the air conditioning device (4) can perform the air conditioning comfortable for the user by using the thermal sensation estimated based on the height.

A child safety seat (303) according to a twenty-first aspect is installed to a rear seat (302) in a car (300) to hold an infant. The child safety seat (303) includes the thermal sensation estimation device (1) of the eleventh aspect and a controller (42). The controller (42) is configured to control an air conditioning device (4) based on the thermal sensation of the infant, estimated by the thermal sensation estimation device (1).

According to this aspect, the child safety seat (303) can hold the infant on the rear seat (302) in the car (300), while performing the air conditioning in accordance with the thermal sensation of the infant.

A thermal sensation estimation method according to a twenty-second aspect is performed by a thermal sensation estimation device (1). The thermal sensation estimation method includes a metabolic amount estimation step (S1), a released heat flux estimation step (S2) and a thermal sensation estimation step (S3). The metabolic amount estimation step (S1) includes estimating a metabolic amount of a user. The released heat flux estimation step (S2) includes estimating a released heat flux as a heat flux released outside from the user. The thermal sensation estimation step (S3) includes estimating thermal sensation of the user based on the metabolic amount and the released heat flux. The metabolic amount estimation step (S1) includes measuring a height of the user to estimate the metabolic amount based on the height measured.

According to this aspect, the metabolic amount of the user is obtained based on the height of the user. The thermal sensation estimation method therefore can contribute to improving accuracy of estimating the thermal sensation of the user.

A program according to a twenty-third aspect is designed to cause one or more processors to perform the thermal sensation estimation method of the twenty-second aspect.

According to this aspect, the metabolic amount of the user is obtained based on the height of the user. The program therefore can contribute to improving accuracy of estimating the thermal sensation of the user.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A thermal sensation estimation device, comprising:
a metabolic amount estimator configured to estimate a metabolic amount of a user;
a released heat flux estimator configured to estimate a released heat flux as a heat flux released outside from the user; and
a thermal sensation estimator configured to estimate thermal sensation of the user based on the metabolic amount and the released heat flux,
the metabolic amount estimator being configured to measure a height of the user to estimate the metabolic amount based on the height measured.

2. The thermal sensation estimation device of claim 1, wherein
the metabolic amount estimator is configured to estimate an age of the user based on the height to estimate the metabolic amount based on the age estimated.

3. The thermal sensation estimation device of claim 2, further comprising a display unit configured to display information about at least one of the height measured, or the age estimated.

4. The thermal sensation estimation device of claim 3, further comprising a correction unit configured to correct the information displayed on the display unit in accordance with an operation by the user or another user.

5. The thermal sensation estimation device of claim 3, further comprising a storage unit configured to store, at predetermined time intervals, information about at least one of the height measured, or the age estimated, wherein
the display unit is configured to display the information stored.

6. The thermal sensation estimation device of claim 1, wherein
the metabolic amount estimator is configured to measure the height based on a thermal image of the user captured by a thermal image capturing device.

7. The thermal sensation estimation device of claim 6, wherein
the released heat flux estimator is configured to estimate the released heat flux based on the thermal image, and
the thermal sensation estimator is configured to estimate the thermal sensation based on:
the height measured based on the thermal image; and
the released heat flux estimated based on the thermal image.

8. The thermal sensation estimation device of claim 1, wherein
the metabolic amount estimator is configured to measure the height based on an image of the user captured by a visible light image capturing device or a near-infrared image capturing device.

9. The thermal sensation estimation device of claim 1, wherein
the metabolic amount estimator is configured to measure the height by using a measuring unit of a holding member holding the user.

10. The thermal sensation estimation device of claim 9, wherein
the measuring unit includes a pressure sensor configured to detect a distribution of pressures applied to a surface in contact with the user, of the holding member.

11. The thermal sensation estimation device of claim 1, wherein
the user is one occupant of a car.

12. The thermal sensation estimation device of claim 11, wherein
the one occupant is present on a rear seat in the car, and
the thermal sensation estimation device further comprises a display unit configured to display, to a driver as another occupant of the car, thermal sensation information about the thermal sensation of the one occupant.

13. The thermal sensation estimation device of claim 12, wherein
the display unit is configured to display the thermal sensation information with being superimposed on an image of the one occupant captured by a visible light image capturing device.

14. The thermal sensation estimation device of claim 13, wherein
the thermal sensation information is a silhouette image covering an area corresponding to the one occupant in the image of the one occupant captured, the silhouette image being changed in color in accordance with the thermal sensation, and
the display unit is configured to change, in accordance with a degree of driving concentrate of the driver, an extent of superimposition to which the silhouette image is superimposed on the image of the one occupant captured, and display the silhouette image at the extent of superimposition changed.

15. The thermal sensation estimation device of claim 14, wherein
the display unit is configured to change the extent of superimposition based on a driving situation of the car, and display the silhouette image at the extent of superimposition changed.

16. The thermal sensation estimation device of claim 1, further comprising an active state estimator configured to estimate an active state of the user, wherein
the metabolic amount estimator is configured to correct, in accordance with the active state, the metabolic amount estimated.

17. An air conditioning device, comprising:
the thermal sensation estimation device of claim 1;
an air conditioning unit configured to perform air conditioning; and
a controller configured to control the air conditioning unit based on the thermal sensation of the user, estimated by the thermal sensation estimation device.

18. A child safety seat to be installed to a rear seat in a car to hold an infant, the child safety seat comprising:
the thermal sensation estimation device of claim 11; and
a controller configured to control an air conditioning device based on the thermal sensation of the infant, estimated by the thermal sensation estimation device.

19. A thermal sensation estimation method to be performed by a thermal sensation estimation device, the thermal sensation estimation method comprising:
estimating a metabolic amount of a user;
estimating a released heat flux as a heat flux released outside from the user; and
estimating thermal sensation of the user based on the metabolic amount and the released heat flux, wherein
during the estimating of the metabolic amount, measuring a height of the user to estimate the metabolic amount based on the height measured.

20. A non-transitory storage medium storing a program designed to cause one or more processors to perform the thermal sensation estimation method of claim 19.
